(19) United States
(12) Patent Application Publication
(10) Pub. No.: US 2016/0253010 A1
(43) Pub. Date: Sep. 1, 2016

(54) Liquid Crystal Display Touch Screen Array Substrate and the Corresponding Liquid Crystal Display Touch Screen

(71) Applicant: Shenzhen China Star Optoelectronics Technology Co. Ltd., Shenzhen, Guangdong (CN)

(72) Inventor: Xiangyang XU, Shenzhen, Guangdong (CN)

(73) Assignee: Shenzhen China Star Optoelectronics Technology Co. Ltd., Shenzhen, Guangdong (CN)

(21) Appl. No.: 14/240,683

(22) PCT Filed: Jan. 9, 2014
(86) PCT No.: PCT/CN2014/070359

§ 371 Date: Feb. 24, 2014

(30) Foreign Application Priority Data
Dec. 26, 2013 (CN) 201310730222.4

(51) Int. Cl. G06F 3/041; G06F 3/042; G02F 1/1333; G02F 1/133; G02F 1/1343; G02F 1/1362; G02F 1/1368; G06F 3/047; G02F 1/1335

(52) U.S. Cl. CPC G06F 3/0412; G06F 3/047; G06F 3/0421; G02F 1/13338; G02F 1/133514; G02F 1/134309; G02F 1/136286; G02F 1/1368; G02F 1/13318

(57) ABSTRACT

The present invention discloses a liquid crystal display touch screen array substrate, which comprises multiple pixel units defined by a gate line and a data line, each pixel unit is provided with a thin film transistor and a pixel electrode inside; the array substrate further comprises: a touch circuit unit used for touch positioning, the touch circuit unit comprising a touch emission line and a touch sensing line intersecting each other, and a light sensing unit provided at the intersection and respectively connected to the touch emission line and the touch sensing line. The touch emission line is the gate line, the touch sensing line is a dummy data line provided on the array substrate, and the dummy data line and the adjacent data line are separated by at least one pixel electrode. The embodiment of the present invention correspondingly discloses a liquid crystal display touch screen. According to the embodiment of the present invention, it can increase the opening ratio, enhance the sensitivity of touch positioning, and improve the product yield.

This application is claiming a priority arisen from a patent application, entitled with “Liquid Crystal Display Touch Screen Array Substrate and the Corresponding Liquid Crystal Display Touch Screen”, submitted to China Patent Office on Dec. 26, 2013, designated with an Application Number 201310730222.4. The whole and complete disclosure of such patent application is hereby incorporated by reference. This application also related to National Stage Application No.: ______ (Attorney Docket No. CP14012), submitted on the same date, entitled, “Liquid Crystal Display Touch Screen Array Substrate and the Corresponding Liquid Crystal Display Touch Screen”; National Stage Application No.: ______ (Attorney Docket No. CP14014), submitted on the same date, entitled, “Embedded Touch Array Substrate and Liquid Crystal Display Panel”; National Stage Application No.: ______ (Attorney Docket No. CP14015), submitted on the same date, entitled, “Array Substrate Common Electrode Structure, the Manufacturing Method Thereof, and Array Substrate” assigned to the same assignee.

### BACKGROUND OF THE INVENTION

1. Field of the Invention

The present invention relates to the technology fields of thin film transistor liquid crystal display (TFT-LCD), and in particular to a liquid crystal display touch screen array substrate and the corresponding liquid crystal display touch screen.

2. The Related Arts

Liquid crystal display (LCD) technology has developed rapidly. It has made great progress from the size of the screen to the display quality. LCD has several characteristics of small size, low power consumption, and no radiation, which has dominated the field of flat panel display.

Liquid crystal display touch screen is one of the major carriers to integrate the input and the output terminal. Recently, with a series of available products of the handheld devices with compact and lightweight, the market demand for liquid crystal display touch screen is surging.

Referring to FIG. 1, the in-cell voltage-sensing liquid crystal display touch screen according to the existing technology utilizes a scanning addressing circuit (including touch emission line 41 and touch sensing line 42) independently realizing the touch function to proceed with touch point positioning. However, there is already a scanning addressing circuit (including horizontal gate line 51 and vertical data line 52) used for display in the pixel structure of the liquid crystal display touch screen. Therefore, when the gate line 51 and the data line 52 used to display intersect with the touch emission line 41 and the touch sensing line 42 used for touch function, it can not only decrease the opening ratio of the pixel, but also increase the process difficulty for preparing liquid crystal display touch screen, and then the bad operation will increase correspondingly. Moreover, the touch sensing line 42 is very close to the data line 52, which will further increase interference within signals.

### SUMMARY OF THE INVENTION

The technical issue to be solved by the present invention is to provide a liquid crystal display touch screen array substrate and the corresponding liquid crystal display touch screen, which can increase the opening ratio, reduce the difficulty of the process, and improve the product yield.

In order to solve the technical issue, the embodiment according to the present invention provides a liquid crystal display touch screen array substrate, which comprises multiple pixel units defined by a gate line and a data line, each pixel unit being provided with a thin film transistor and a pixel electrode inside;

wherein, the array substrate further comprises:
a touch circuit unit used for touch positioning, the touch circuit unit comprising a touch emission line and a touch sensing line intersecting each other, and a light sensing unit provided at the intersection and respectively connected to the touch emission line and the touch sensing line, the touch emission line being the gate line, the touch sensing line being a dummy data line provided on the array substrate, and the dummy data line and the adjacent data line being separated by at least one pixel electrode.

Wherein, the touch sensing line is arranged at equal intervals.

Wherein, the light sensing unit is a photodiode.

Wherein, the photodiode and the active layer of the thin film transistor utilize the same patterning.

Wherein, it further comprises an amplifying circuit and a signal processing unit connected with each said touch sensing line.

Correspondingly, the embodiment of the present invention further provides an liquid crystal display touch screen array substrate, which comprises multiple pixel units defined by a gate line and a data line, each pixel unit being provided with a thin film transistor and a pixel electrode inside;

wherein, the array substrate further comprises:
a touch circuit unit used for touch positioning, the touch circuit unit comprising a touch emission line and a touch sensing line intersecting each other, and a light sensing unit provided at the intersection and respectively connected to the touch emission line and the touch sensing line, the touch emission line being the gate line, the touch sensing line being a dummy data line provided on the array substrate, the dummy data line and the adjacent data line being separated by at least one pixel electrode, and the touch sensing line being arranged at equal intervals.

Wherein, the light sensing unit is a photodiode.

Wherein, the photodiode and the active layer of the thin film transistor utilize the same patterning.

Wherein, it further comprises an amplifying circuit and a signal processing unit connected with each said touch sensing line.

Correspondingly, the embodiment of the present invention further provides a liquid crystal display touch screen, comprising:

an array substrate, which comprises multiple pixel units defined by a gate line and a data line, each pixel unit being provided with a thin film transistor and a pixel electrode inside;
a color filter substrate, which is opposite to the array substrate; and
a liquid crystal layer, which is provided between the array substrate and the color filter substrate;
wherein, the array substrate further comprises:
a touch circuit unit used for touch positioning, the touch circuit unit comprising a touch emission line and a touch sensing line intersecting each other, and a light sensing unit provided at the intersection and respectively connected to the touch emission line and the touch sensing line, the touch emission line being the gate line, the touch sensing line being a dummy data line provided on the array substrate, and the dummy data line and the adjacent data line being separated by at least one pixel electrode.

Wherein, the touch sensing line is arranged at equal intervals.

Wherein, the light sensing unit is a photodiode.

Wherein, the photodiode and the active layer of the thin film transistor utilize the same patterning.

Wherein, it further comprises an amplifying circuit and a signal processing unit connected with each said touch sensing line.

The embodiment of the present invention has the following beneficial effects.

In the embodiment of the present invention, the gate line has the function of the touch emission line in the touch circuit unit used for touch positioning, and the dummy data line has the function of the touch sensing line. That is, the gate line used for displaying and the touch emission line used for touch are combined, and the dummy data line and the touch sensing line are combined, which gives the same scanning signals through the IC. It can realize touch positioning while displaying images. The scheme reduces the line arranged density and increases the opening ratio in pixels by using the gate line as the touch emission line used for touch. At the same time, it also reduces the processing number, decreases the difficulty of the process, and improves the product yield.

Moreover, because the touch sensing line and the dummy data line are common, the distance between which and the other signal lines is increased, it can reduce the interference of signal lines and enhance the sensitivity of touch positioning.

### BRIEF DESCRIPTION OF THE DRAWINGS

In order to more clearly illustrate the embodiment of the present invention or the technical issue of the prior art, the accompanying drawings and the detailed descriptions are as follows. Obviously, the following description of the accompanying drawings are only some embodiments according to the present invention, for persons of ordinary skill in this field, they can also obtain other drawings based on these drawings without creative effort.

FIG. 1 is a schematic view illustrating the structure of a liquid crystal display touch screen according to the existing technology;

FIG. 2 is a schematic view illustrating the structure of a liquid crystal display touch screen array substrate according to an embodiment of the present invention;

FIG. 3 is a partial enlarged schematic of FIG. 2;

FIG. 4 is a circuit block diagram of a liquid crystal display touch screen array substrate proceeding with touch positioning according to the present invention;

FIG. 5 is a first timing relationship diagram of the touch control circuit unit of the liquid crystal display touch screen array substrate proceeding with touch addressing according to the present invention; and

FIG. 6 is a second timing relationship diagram of the touch control circuit unit of the liquid crystal display touch screen array substrate proceeding with touch addressing according to the present invention.

### DETAILED DESCRIPTION OF THE PREFERRED EMBODIMENTS

The following description of the embodiments with reference to the attached drawings, the present invention may be used to illustrate the specific embodiments to implement. The present invention mentioned directional terms, such as “upper”, “lower”, “front”, “rear”, “Left”, “Right”, “top”, “bottom”, “horizontal”, “vertical”, etc. only with reference to the accompanying drawings, in the direction. Therefore, the use of directional terms are used to describe and understand the present invention and not intended to limit the present invention.

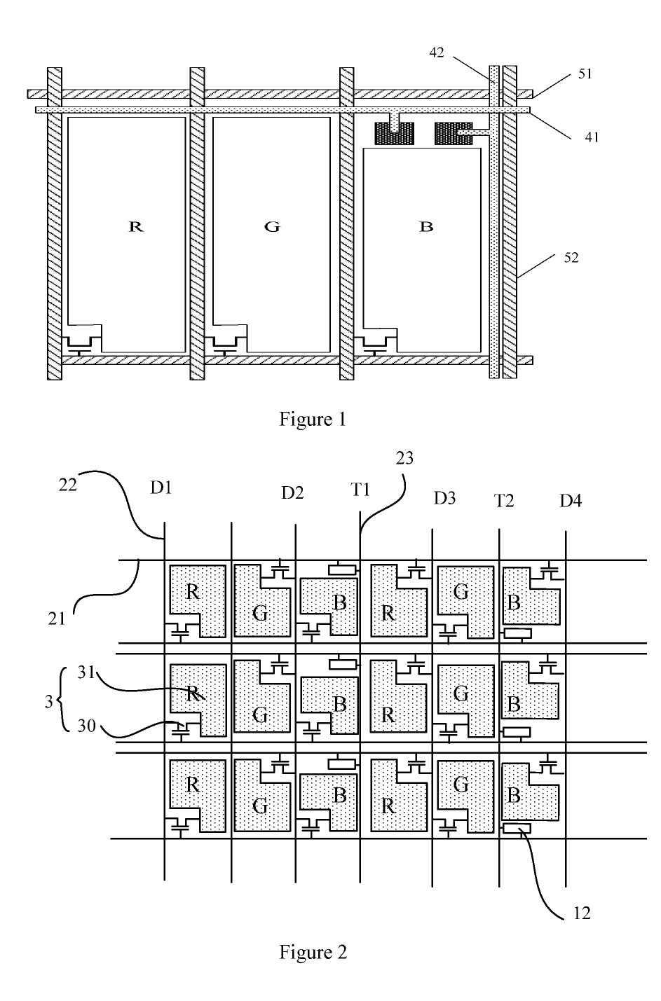

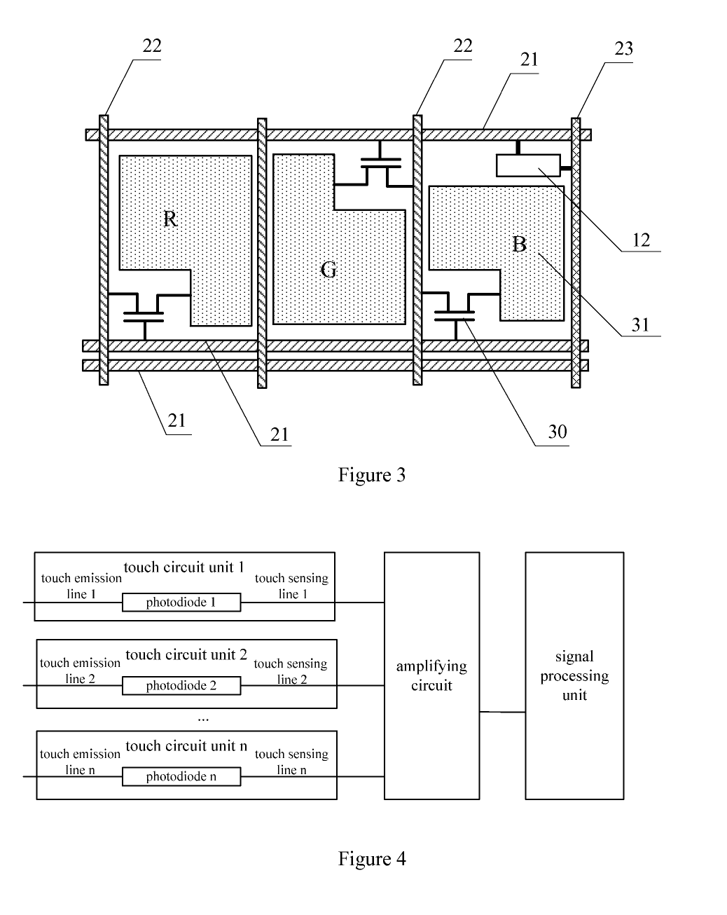

Referring to FIGS. 2 and 3, it shows a liquid crystal display touch screen array substrate according to an embodiment of the present invention. In the embodiment, the liquid crystal display touch screen array substrate comprises multiple pixel units 3 defined by multiple gate lines 21 and multiple data lines 22. Each pixel unit 3 is provided with a thin film transistor 30 and a pixel electrode 31 (see D1 to D4 shown in Figure) inside. The array substrate further comprising: a touch circuit unit used for touch positioning, the touch circuit unit comprising a touch emission line and a touch sensing line intersecting each other, and a light sensing unit 12 provided at the intersection and respectively connected to the touch emission line and the touch sensing line. Wherein, the touch emission line is the gate line 21, the touch sensing line is a dummy data line 23 (see T1 and T2 shown in Figure) provided on the array substrate, and the dummy data line 23 and the adjacent data line is separated by at least one pixel electrode 31.

Preferably, in the display screen using dual gate line, the touch emission line is one of the dual gate lines.

The light sensing unit 12 is a photodiode, which is turned on when receiving light and turned off when the light is blocked. The photodiode can be formed as a switch to detect if touch or not. If there is touch, the light emitting to the photodiode is blocked. The photosensitive semiconductor in the photodiode is a-Si or low-temperature polysilicon, which utilizes the same patterning as the active layer of the thin film transistor 30.

Furthermore, the touch circuit unit can be provided on the at least one pixel unit. The pixel size of the liquid crystal display is usually smaller, and the contact area of human finger touching screen is generally larger, which indicates that it is not necessary to provide a touch circuit unit inside the each pixel unit. Since the touch emission line is shared with the gate line, the touch emission line scans each row of the pixel units. Every several pixels provides with a row of the touch sensing circuit according to the practical needs. For example, in an embodiment, the touch sensing lines can be arranged at equal intervals, such as one touch sensing line every two pixels. It can be understood that it can provide one touch sensing line every multiple pixels. In order to keep a certain distance away from the data line, the dummy data line and the adjacent data line is separated by at least one pixel electrode. In this way, it can reduce the number of the touch sensing lines provided on the array substrate, which can improve the processing efficiency of the touch signal.

Referring to FIG. 4, it is a circuit block diagram of a liquid crystal display touch screen array substrate proceeding with touch positioning according to the present invention. In the present embodiment, the touch circuit unit is connected to an amplifying circuit. The amplifying circuit is connected to the control sensing line of the touch circuit unit. The amplifying circuit is also connected to a signal processing unit. It can be understood that the amplifying circuit can be an operational amplifying circuit.

The photodiode in the touch circuit unit is used to detect if the screen is touched or not. When the photodiode shows no touch on the screen, the photodiode is turned on due to external light. The scanning signal on the gate line is transferred to the signal processing unit through the photodiode and the touch receiving line after being amplified by the amplifying circuit. If there is touch, the photodiode is turned off because the touching object blocks the photodiode, and then the scanning signal on the gate line can not be transferred to the signal processing unit. The signal processing unit can judge if each photodiode is turned on or off through the receiving signal, and then position the touch area according to the position of the cutoff photodiode.

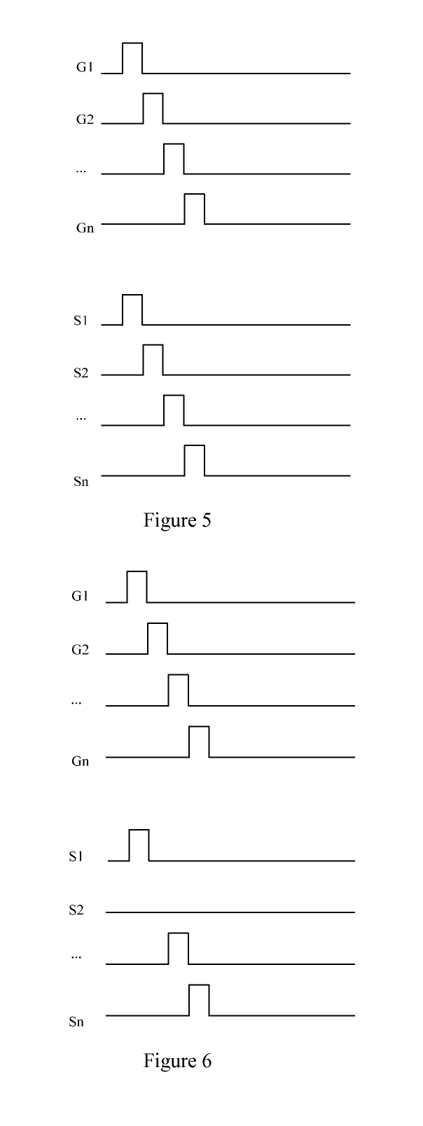

FIGS. 5 and 6 show the first timing relationship diagram of the touch control circuit unit proceeding with touch addressing. Wherein, G1, G2, . . . Gn respectively represent the driving signal (scanning signal) of the n-th row of the gate line of the liquid crystal display touch screen array substrate, and S1, S2, . . . Sm respectively represent the addressing signal of the m-th row of the touch circuit unit.

Referring to FIG. 5, when the liquid crystal display touch screen normally display, namely, there is no touch action, the gate line proceeds with periodic scanning according to the refresh frequency, the touch sensing line is connected to the external signal processing unit, and each photodiode is turned on, so the addressing signal received by the external signal processing unit is the same as the driving signal of the gate line.

Referring to FIG. 6, when there is touch operation on the liquid crystal display touch screen, the light on one of the photodiode is blocked. The photodiode will be turned off, so the output level of the touch sensing line connected with the photodiode is low level, as the addressing signal S2 shown in Figure. Therefore, the signal processing unit can position the specific touch area according to the addressing signal S2 and the scanning frequency of the common electrode. Similarly, when there is multi-touch operation on the liquid crystal display touch screen, the signal processing unit can respectively position the signal changes of different touch sensing lines to achieve the multi-touch function.

Correspondingly, the embodiment of the present invention further provides a liquid crystal display touch screen which comprises an array substrate comprising multiple pixel units defined by a gate line and a data line, each pixel unit being provided with a thin film transistor and a pixel electrode inside;

a color filter substrate, which is opposite to the array substrate; and
a liquid crystal layer, which is provided between the array substrate and the color filter substrate;
wherein, the array substrate further comprises:
a touch circuit unit used for touch positioning, the touch circuit unit comprising a touch emission line and a touch sensing line intersecting each other, and a light sensing unit provided at the intersection and respectively connected to the touch emission line and the touch sensing line, the touch emission line being the gate line, the touch sensing line being a dummy data line provided on the array substrate, and the dummy data line and the adjacent data line being separated by at least one pixel electrode.

Wherein, the touch sensing line is arranged at equal intervals.

Wherein, the light sensing unit is a photodiode.

Wherein, the touch circuit unit is provided on the at least one pixel unit.

Wherein, the photodiode and the active layer of the thin film transistor utilize the same patterning.

Wherein, it further comprises an amplifying circuit and a signal processing unit connected with each said touch sensing line.

It can be understood that the more detail about the array substrate can refer to the illustration of FIGS. 2 to 6, which is not repeated here.

In summary, the embodiment of the present invention has the following beneficial effects.

In the embodiment of the present invention, the gate line has the function of the touch emission line in the touch circuit unit used for touch positioning, and the dummy data line has the function of the touch sensing line. That is, the gate line used for displaying and the touch emission line used for touch are combined, and the dummy data line and the touch sensing line are combined, which gives the same scanning signals through the IC. It can realize touch positioning while displaying images. The scheme reduces the line arranged density and increases the opening ratio in pixels by using the gate line as the touch emission line used for touch. At the same time, it also reduces the processing number, decreases the difficulty of the process, and improves the product yield.

Moreover, because the touch sensing line and the dummy data line are common, the distance between which and the other signal lines is increased, it can reduce the interference of signal lines and enhance the sensitivity of touch positioning.

In addition, the technical embodiment of the present invention can be applied to large-size liquid crystal display panel.

The preferred embodiments according to the present invention are mentioned above, which cannot be used to define the scope of the right of the present invention. Those modifications and variations are considered encompassed in the scope of protection defined by the clams of the present invention.

What is claimed is:

1. A liquid crystal display touch screen array substrate, which comprises multiple pixel units defined by a gate line and a data line, each pixel unit being provided with a thin film transistor and a pixel electrode inside;
wherein, the array substrate further comprises:
a touch circuit unit used for touch positioning, the touch circuit unit comprising a touch emission line and a touch sensing line intersecting each other, and a light sensing unit provided at the intersection and respectively connected to the touch emission line and the touch sensing line, the touch emission line being the gate line, the touch sensing line being a dummy data line provided on the array substrate, and the dummy data line and the adjacent data line being separated by at least one pixel electrode.

2. The liquid crystal display touch screen array substrate as claimed in claim 1, wherein the touch sensing line is arranged at equal intervals.

3. The liquid crystal display touch screen array substrate as claimed in claim 2, wherein the light sensing unit is a photodiode.

4. The liquid crystal display touch screen array substrate as claimed in claim 3, wherein the photodiode and the active layer of the thin film transistor utilize the same patterning.

5. The liquid crystal display touch screen array substrate as claimed in claim 4, wherein it further comprises an amplifying circuit and a signal processing unit connected with each said touch sensing line.

6. A liquid crystal display touch screen array substrate, which comprises multiple pixel units defined by a gate line and a data line, each pixel unit being provided with a thin film transistor and a pixel electrode inside;
wherein, the array substrate further comprises:
a touch circuit unit used for touch positioning, the touch circuit unit comprising a touch emission line and a touch sensing line intersecting each other, and a light sensing unit provided at the intersection and respectively connected to the touch emission line and the touch sensing line, the touch emission line being the gate line, the touch sensing line being a dummy data line provided on the array substrate, the dummy data line and the adjacent data line being separated by at least one pixel electrode, and the touch sensing line being arranged at equal intervals.

7. The liquid crystal display touch screen array substrate as claimed in claim 6, wherein the light sensing unit is a photodiode.

8. The liquid crystal display touch screen array substrate as claimed in claim 7, wherein the photodiode and the active layer of the thin film transistor utilize the same patterning.

9. The liquid crystal display touch screen array substrate as claimed in claim 8, wherein it further comprises an amplifying circuit and a signal processing unit connected with each said touch sensing line.

10. A liquid crystal display touch screen, comprising:
an array substrate, which comprises multiple pixel units defined by a gate line and a data line, each pixel unit being provided with a thin film transistor and a pixel electrode inside;
a color filter substrate, which is opposite to the array substrate; and
a liquid crystal layer, which is provided between the array substrate and the color filter substrate;
wherein, the array substrate further comprises:
a touch circuit unit used for touch positioning, the touch circuit unit comprising a touch emission line and a touch sensing line intersecting each other, and a light sensing unit provided at the intersection and respectively connected to the touch emission line and the touch sensing line, the touch emission line being the gate line, the touch sensing line being a dummy data line provided on the array substrate, and the dummy data line and the adjacent data line being separated by at least one pixel electrode.

11. The liquid crystal display touch screen as claimed in claim 10, wherein the touch sensing line is arranged at equal intervals.

12. The liquid crystal display touch screen as claimed in claim 10, wherein the light sensing unit is a photodiode.

13. The liquid crystal display touch screen as claimed in claim 12, wherein the photodiode and the active layer of the thin film transistor utilize the same patterning.

14. The liquid crystal display touch screen as claimed in claim 13, wherein it further comprises an amplifying circuit and a signal processing unit connected with each said touch sensing line.
